(19) United States
(12) Patent Application Publication
(10) Pub. No.: US 2007/0105063 A1
(43) Pub. Date: May 10, 2007

(54) Multi-function oral care device

(76) Inventors: Aleksey Mikhailovich Pinyayev, West Chester, OH (US); Chanchal Kumar Ghosh, West Chester, OH (US)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(21) Appl. No.: 11/592,674

(22) Filed: Nov. 3, 2006

Related U.S. Application Data
(60) Provisional application No. 60/733,711, filed on Nov. 4, 2005.

(51) Int. Cl. A61C 3/00

(52) U.S. Cl. 433/29

(57) ABSTRACT

An oral device having a multi-purpose handle which can be connected to a variety of head assemblies to provide distinct oral care benefits. The head assembly can be light emitting and bristle-less, and can comprise a spacing element. The spacing element can provide the user with a means to determine the proper distance between the oral surface and the light emitting element. The spacing element may also stimulate a tactile response to indicate to the user the location of the light emitting element within the oral cavity.

### CROSS REFERENCE TO RELATED APPLICATION

This Application claims the benefit of U.S. Provisional Application No. 60/733,711 filed on Nov. 4, 2005.

### FIELD OF THE INVENTION

The present invention relates to illuminated electric oral devices that utilize a light emitting element within the oral cavity. More particularly, the invention relates to the delivery of light to the oral cavity to provide multiple oral care benefits.

### BACKGROUND OF THE INVENTION

Lighted oral devices such as lighted toothbrushes, mouth guards and trays project light into the mouth using fiber optics or have light emitting elements that are surrounded by bristles. Other devices, which project light from outside the mouth into the oral cavity, use light of high power and intensity, such as lasers. Examples of lighted oral devices and methods of use include those disclosed in U.S. applications Ser. No. 10/887,644, 10/842,302, 10/888,206, 10/887,667, 10,832,168, 10/847,429, 11/099737, 10/777,020, 60/586,560, 60/667,499, and 60,676,680. Many of these devices are used for a single benefit such as whitening or curing of compositions such as dental fillings.

A desire exists to provide the consumer with an oral care system that can provide multiple distinct oral care benefits. In particular, a desire exists to use light to provide an oral benefit. The user can customize the oral care system using a head assembly which provides the desired oral benefit.

To provide an oral benefit with light, the light must have a certain wavelength and intensity. Often times the benefit is linked to the light quality. For example, light having a wavelength resulting in a blue color can provide a whitening benefit. Having an oral device with a light emitting element which can be placed into close proximity to the oral surface can deliver the desired light qualities that can achieve an oral benefit without using lasers, and the light can be delivered with power from a battery contained within the oral device.

Delivering the beneficial quality of light may require a particular distance between the light emitting element and the oral surface (“spacing”) and for the user to know the location of the light within the oral cavity. As the device is used within the oral cavity it may be difficult to establish this spacing and location visually. Therefore, a device which can provide the user with a non-visual indicator of proper spacing and location is desired. Additionally, a need exists to provide an oral device having a size that allows the user to move the device around within the oral cavity to expose a variety of oral surfaces to the light.

It has been found that an oral care system which has removable and replaceable head assemblies providing distinct oral care benefits which can be attached to a single multi-purpose handle enables the user to have one system that can address multiple oral care needs. This device can have light emitting bristle-less heads which comprise a spacing element. The spacing element is a non-visual indicator of the proper spacing between the light emitting element and the oral surface. This spacing element can also stimulate a tactile response to indicate to the user the current location of the light emitting element within the oral cavity. Additionally, this oral care device can be provided in a kit with one multi-purpose handle and multiple removable/replaceable head assemblies which can provide distinct oral benefits; including but not limited to whitening, anti-bacterial, cleaning, anti-tartar, anti-plaque, etc. . . .

### SUMMARY OF THE INVENTION

The present invention relates to an electric oral device comprising a handle, a bristle-less head, and a neck extending between the handle and the head; wherein the head comprises a light emitting element, and further comprises a spacing element for providing a distance between the light emitting element and an oral surface. The head comprising a light emitting element does not comprise a cleaning implement.

The present invention also relates to an electric oral device comprising a handle, a bristle-less head, and a neck extending between the handle and the head. The head comprises a light emitting element and a spacing element, the spacing element comprising a wall extending in a direction perpendicular to the head. The spacing element provides a distance between the light emitting element and an oral surface.

The present invention also relates to an electric oral device comprising a handle, a bristle-less head, and a neck extending between the handle and the head. The head comprises a light emitting element, and a spacing element. The spacing element provides a distance between the light emitting element and an oral surface, and the spacing element comprises less than four protuberances.

The present invention also relates to an oral care kit comprising a multi-purpose handle having a power source and a motor; and two or more removable head assemblies; at least one of the head assemblies is bristle-less and comprises a light emitting element which is operatively connectable to the power source and at least one of the head assemblies comprises a movable bristle holder which is operatively connectable to the motor.

### BRIEF DESCRIPTION OF THE DRAWINGS

While the specification concludes with claims particularly pointing out and distinctly claiming the invention, it is believed that the present invention will be better understood from the following description taken in conjunction with the accompanying drawings in which:

FIG. 1 is a perspective view of a light emitting bristle-less oral device of the present invention in which the oral device includes a head having a light emitting element and a spacing element, a neck and a handle.

FIG. 2 is a perspective view of a light emitting bristle-less oral device of the present invention in which the light emits from the surface of the spacing element.

FIG. 3 is a perspective view of a light emitting bristle-less oral device of the present invention in which the light emits from a portion of the surface of the spacing element.

FIG. 4 is a cross-sectional side view of a light emitting bristle-less oral device of the present invention.

FIG. 5 is a side elevational view of a head, neck, spacing element and a portion of a handle of an oral device of the present invention.

FIG. 6 is a side view of an oral device of the present invention and an elevational view of the teeth.

FIG. 7 is a side view of an oral device of the present invention and an elevational view of the teeth.

FIGS. 8, 8A and 8B are a partial side elevational view of the head assembly of the present invention.

FIG. 9 is a side view of an oral device of the present invention comprising a rotatable spacing element.

FIG. 10 is an exploded partial front view of a head assembly comprising a rotatable spacing element.

FIG. 10A is a side view of an oral device of the present invention comprising a rotatable head assembly.

FIG. 11 is a partial side view of a head assembly of the present invention comprising elastomeric walls and a light emitting element.

FIG. 12 is a partial front view of a head assembly of the present invention comprising elastomeric walls and a light emitting element.

FIG. 13 is a partial side view of a head assembly of the present invention comprising elastomeric walls and two light emitting elements.

FIG. 14 is a partial front view of a head assembly of the present invention comprising elastomeric walls and two light emitting elements.

FIG. 15 is a partial side view of a head assembly of the present invention comprising elastomeric cylinders and a light emitting element.

FIG. 16 is a partial front view of a head assembly of the present invention comprising elastomeric walls and a light emitting element.

FIG. 17 is a partial side view of a head assembly of the present invention comprising rectangular elastomeric bars and a light emitting element.

FIG. 18 is a partial front view of a head assembly of the present invention comprising rectangular elastomeric bars and a light emitting element.

FIG. 19 is a partial side view of a head assembly of the present invention comprising elastomeric rods and a light emitting element.

FIG. 20 is a partial front view of a head assembly of the present invention comprising elastomeric rods and a light emitting element.

FIG. 21 is a partial side view of a head assembly of the present invention comprising elastomeric bars and a light emitting element.

FIG. 22 is a partial front view of a head assembly of the present invention comprising elastomeric bars and a light emitting element.

FIG. 23 is a partial side view of a head assembly of the present invention comprising ball elements and a light emitting element.

FIG. 24 is a partial front view of a head assembly of the present invention comprising ball elements and a light emitting element.

FIG. 25 is a partial side view of a head assembly of the present invention comprising a ball element within a column and a light emitting element.

FIG. 26 is a partial front view of a head assembly of the present invention comprising a ball element within a column and a light emitting element.

FIG. 27 is a partial side view of a head assembly of the present invention comprising a ball element within a spring loaded column and a light emitting element.

FIG. 28 is a partial front view of a head assembly of the present invention comprising a ball element within a spring loaded column and a light emitting element.

FIG. 29 is a partial side view of a head assembly comprising bristles.

FIG. 30 is a partial side view of a head assembly comprising a cap-type spacing element.

FIG. 31 is a partial side view of a head assembly comprising ball element type spacing element.

FIG. 32 is a partial front view of a multi-purpose handle.

FIG. 33 is a partial front view of an oral device of the present invention.

FIG. 34 is a cross-sectional side view of a light emitting bristle-less oral device of the present invention.

### DETAILED DESCRIPTION OF THE INVENTION

The oral device of the present invention has a simplified design which includes multiple head assemblies which are removable and/or replaceable and which can be attached to a multi-purpose handle. The portion of the device which is removable can comprise the head only, a head and neck combination, or the head and a portion of the neck. As referenced herein, “head assembly” comprises all of these variations. The user can choose to attach to the multi-purpose handle the head assembly which provides the desired oral benefit. At least a portion of the head assembly of the oral device of the present invention is sized for use in an oral cavity, and can be moved about the oral cavity. In one embodiment, a head assembly comprising a light emitting element and no bristles is attached to the multi-purpose handle. The head assembly is placed into the oral cavity, exposing the oral surface to light. The light provides a cosmetic benefit, including whitening of the teeth. In another embodiment exposing the oral surface to light can treat an oral condition. By “oral condition” as used herein is meant diseases or conditions of the oral cavity including caries, plaque, breath malodor, dental erosion, gingivitis, and periodontal disease. Oral conditions are further described in WO 02/02096A2, published Jan. 10, 2002, P&G. The multi-purpose handle can provide power connection between the head and the power source which can be disposed in the handle; as well as a mechanical connection between the head and the motor which can be disposed in the handle. Examples of power connections include those connections disclosed in U.S. patent application Ser. No. 10/847,429. Examples of mechanical connections include those connections disclosed in U.S. Pat. Nos. 6,360,395 and 5,617,601 and U.S. patent application Ser. Nos. 10/351,845, 10/361,653, 10/114,780 and 10/128,018. Each head assembly can provide a distinct oral care benefit. For example, a head assembly which comprises a light emitting element which emits in the blue wavelength can provide a whitening function, whereas a separate head comprising a light emitting element which emits light in the red or ultraviolet wavelength can provide a bacterial kill function. Examples of light wavelengths and the resulting oral benefit include the light treatments disclosed in U.S. patent application Ser. Nos. 10/777,020, 60/676,680, 60/667,499, and 10/887,667.

In one embodiment of the present invention the light emitting head assemblies are bristle-less. As used herein the term “bristle-less” means free of a cleaning implement.

The term “cleaning implements” as used herein means tufts of bristles and/or more than five elastomeric elements disposed on one single head assembly. In particular cleaning implements comprise more than five elastomeric walls or fingers disposed on a single head. The light emitting head assemblies do not comprise cleaning implements to allow for a more simplified head design.

As used herein the term “oral surfaces” refers to all surfaces, including both hard and soft tissues, within the oral cavity. As used herein, the term “light” is intended to encompass the spectrum of both visible, near visible and non-visible (e.g., ultraviolet and infra-red) light. In one embodiment of the oral device of the present invention the light emitted from the light emitting element can be from about 370, 390, 410, 430, 450, 470, 490, 510, 530, 550, 570, 590, 610, 630, 650, 670, 690, 710 nm and/or less than about 770, 750, 730, 710, 690, 670, 650, 630, 610, 500, 400 nm. In another embodiment the light emitted can have a wavelength of greater than about 420, 430, 440, 450, 460, 470, 480, and/or 490 nm and/or less than about 490, 480, 470, 460, 450, 440, 430 nm. In yet another embodiment the light emitted can have a wave length from about 420, 430, 440, 450, 460, 470 nm and/or less than about 470, 460, 450, 430 nm. It will be appreciated that the particular range of wavelengths selected can depend upon the desired color of the light. In one embodiment the light emitted can be a blue color. Further, the term “light emitting element” refers to light emitting diodes, incandescent elements, laser elements, halogen elements, neon elements, fluorescent elements, plasma elements, xenon elements, and/or any combination thereof.

The oral device can be sold alone, or as a kit. The kit can contain a multi-purpose handle, one or more compositions and one or more removable replaceable head assemblies, including but not limited to a bristle-less light emitting head, a non-light emitting, bristle bearing head with movable bristles, as well as a head comprising an element including but not limited to, a flosser, massaging elements, scraping elements, heat emitting elements, sonic wave emitting elements, ultra-sound emitting element, electric current emitting elements, substance emitting elements and/or any combination thereof.

The oral devices of the present invention can be used alone or in combination with an oral care composition containing a safe and effective amount of an oral care active. p By “oral care composition” or “oral composition” as used herein is meant a product which is not intentionally swallowed for purposes of systemic administration of therapeutic agents, but is retained in the oral cavity for a sufficient time to contact substantially all of the dental surfaces and/or mucosal tissues for purposes of oral activity. In addition these terms can mean a product which may be intentionally swallowed but not swallowed for the purposes of systemic administration of therapeutic agents. Such oral care compositions include dentifrices, gels, rinses, edible films, and lozenges. The term “oral care active” as used herein means a material that provides either a cosmetic, prophylactic or therapeutic benefit within the oral cavity. By “safe and effective amount”, as used herein, is meant an amount of an agent (e.g., anti-calculus agent) high enough to significantly improve the condition to be treated, but low enough to avoid serious side effects (at a reasonable benefit/risk ratio), within the scope of sound medical/dental judgment. The safe and effective amount of an agent (e.g., anti-calculus agent) may vary with the particular condition being treated, the age and physical condition of the patient being treated, the severity of the condition, the duration of treatment, the nature of concurrent therapy, the specific form of the source employed, and the particular vehicle from which the agent is applied. Examples of compositions that are suitable for use with the present invention include those referenced in U.S. Pat. Nos. 5,645,428, 6,416,319, 6,616,451, 5,658,148, and 6,343,400, and application Ser. Nos. 10/777,020, 10/887,667, 10/895,694, 60/676,680, and 60/667,499.

The oral care composition may be applied to the device and then to the oral surface or the composition may be first applied to the oral surface and then the oral device is used to illuminate the oral care composition and the oral surface.

The oral device of the present invention comprises a multi-purpose handle, a head assembly, and a neck which extends between the handle and the head. If the replaceable head assembly comprises a powered element, such as a light emitting element, the multi-purpose handle provides power to the head assembly; and the multi-purpose handle can have severable electrical connectors to provide ease of removing and replacing the bristle-less light emitting head assembly. Additionally, if the replaceable head assembly comprises a movable component, such as a movable bristle holder, the multi-purpose handle can comprise a motor and additionally can provide a mechanical connection between the movable bristle holder and the motor. In one embodiment this mechanical connection is provided with a drive shaft which connects the motor to the movable bristle holder. In another embodiment the motor of the multi-purpose handle is not activated when the light emitting head assembly is connected to the multi-purpose handle, therefore the mechanical connector, such as the drive shaft, is not in operation unless the head assembly comprising a movable element such as a bristle holder is connected to the multi-purpose handle. In one embodiment the multi-purpose handle has a coupling system for coupling to various heads, and a control device for controlling the different mechanisms, including drive mechanism and power mechanism. The multi-purpose handle includes an electronic interlock device, so that only the mechanisms of the multi-purpose handle that are needed for the particular attached head are activated. In this embodiment the interlocking device deactivates the unnecessary mechanisms when the head is connected to the multi-purpose handle. One interlocking device that is suitable for use with the present invention is described in U.S. patent application Ser. No. 10/871,469. The multi-purpose handle can connect to the head assembly via any mechanical connection including, but not limited to, those connections disclosed in U.S. patent application Ser. Nos. 09/850,662 and 10/659,788.

The oral device has a handle shaped for holding in the hand, and a head shaped for placement in the oral cavity. The length of the entire oral device including the head, the neck and the multi-purpose handle and is measured along the longitudinal axis of the oral device from the distal end of the oral device head to the proximal end of the multi-purpose handle. Generally the length of the oral device length is greater than about 10 cm, about 12 cm, about 14 cm, about 16 cm, about 18 cm, and/or less than about 20 cm, about 22 cm, about 24 cm, about 26 cm and/or any combination thereof.

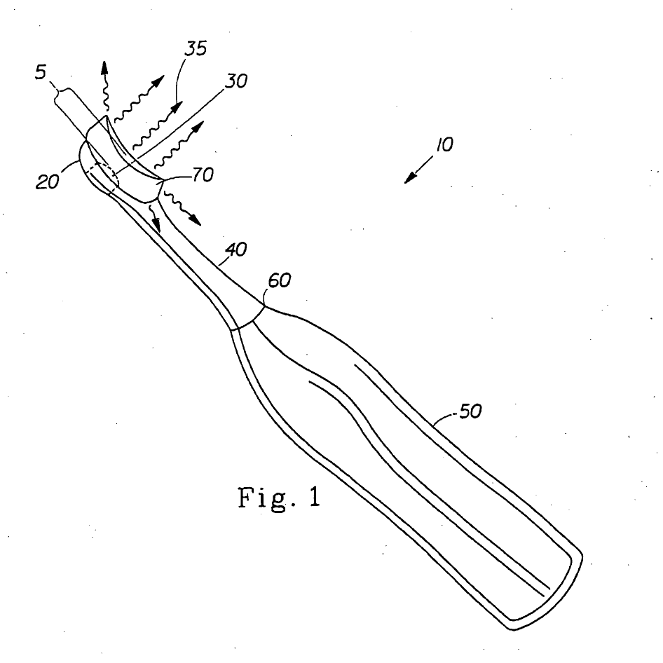

When a bristle-less light emitting head assembly is attached to the multi-purpose handle, it may be beneficial to indicate to the user the proper distance between the light emitting element and the oral surface (“spacing”), as well as the location of the light emitting element within the oral cavity to ensure the desired light qualities are delivered to the particular oral surface. This spacing (shown at 5, in FIG. 1) between the light emitting element and the oral surface can be from about 0.1, 0.2, 0.3, 0.50, 0.60, 0.63, 0.64, 0.66, 0.68. 0.70, 0.72, 0.74, 0.76, 0.80, 0.85, 0.90, and/or 1.0 cm and or less than about 2.0, 1.5, 1.4, 1.3, 1.25, 1.20, 1.15, 1.1, 1.05, 1.0, 0.5 cm and/or any combination thereof. In one embodiment this spacing is measured as the shortest distance between the tip of the light emitting surface of the light emitting element and the surface of the spacing element to be placed proximal to the oral surface (as shown in FIGS. 1-3). In another embodiment the spacing is measured as the shortest distance between the lens of a light emitting diode and the labial surface of the teeth. A spacing element can be used to provide the user with a spacing and/or locating signal. The light emitting element can extend into a portion of the spacing element, or can be completely disposed within the head of the toothbrush. The spacing element can be sized so that the desired distance is provided between the light emitting element and the oral surface. The spacing element is any element, excluding tufts of bristles, located on the head of the oral device that extends from the head in the same direction as the light emits. The spacing element includes, but is not limited to, a cap extending over all or a portion of the surface of the head of the oral device, rollers or balls disposed on the head of the oral device, elastomeric elements embedded into the head of the oral device and/or any combination of these. The spacing element, in particular the elastomeric elements, can comprise a variety of shapes, including but not limited to, walls, cylinders, spikes, circles, semi-circles, rectangles, squares and any combination of these shapes. However, the spacing element is comprised of five or less individual elements, such as elastomeric elements, in order to provide the simplified design of the present invention, and prevent build up of composition around the light emitting element. Additionally, the spacing element may swivel and/or rotate so that the user can hold the handle in the most comfortable manner, and the spacing element can still be held against the oral surface. This spacing element can rotate from greater than about 10, 20, 30, 40, 45, 50, 60, 70, 80, 90, 95, 100, 120, 130, 140, 150, 160, 170, 180 degrees, and/or less than about 175, 170, 160, 150, 140, 130, 120, 100, 95, 90, 85, 80, 70, 60, 50, 45, 40, 30, 20 degrees and/or any combination thereof. In another embodiment the neck can have a joint and/or a swivel which enables the user to rotate the head thereby moving the handle away from portions of the face to avoid contact between the handle and the face or teeth during use. Additionally, the user can combine the rotation of the spacing element and swiveling or rotation of the head assembly to provide the most comfortable operation of the oral device. The joint allows the head to rotate from greater than about 10, 20, 30, 40, 45, 50, 60, 70, 80, 90, 95, 100, 120, 130, 140, 150, 160, 170, 180 degrees, and/or less than about 175, 170, 160, 150, 140, 130, 120, 100, 95, 90, 85, 80, 70, 60, 50, 45, 40, 30, 20 degrees and/or any combination thereof. In one embodiment the head assembly rotates from about 0 to about 90 degrees. In another embodiment the head assembly rotates from about 45 to about 90 degrees.

The spacing elements can be protuberances. Protuberances are outwardly extending members, which extend in the same direction the light emits. The spacing element can be from about 1, 2, 3, 4, and/or less than about 4, 3, 2 protuberances and/or any combination thereof. More than five protuberances may result in trapping of the composition on or around the light emitting element, depending on the rheological properties of the composition and the shape and/or size of the protuberances. The protuberance can be a cap, a wall, rollers or any other shape including, but not limited to, a cylinder, a circle, a semi-circle, a square, and/or any combination thereof. The spacing element disposed on the head of the oral device can provide a signal to the user to indicate the proper distance between the oral surface to be treated and the light emitting element. To provide a spacing signal the spacing element is sized so that when the surface of the spacing element is placed against the oral surface to be treated, the light emitting element is the appropriate distance from the oral surface, therefore providing light of the intensity and wavelength to result in the desired oral benefit. For example, the spacing element can extend from the head perpendicular to the longitudinal axis of the oral device, and the height of the spacing element is the distance between the light emitting element and the oral surface. The height of the spacing element can be from about 0.1, 0.2, 0.3, 0.50, 0.60, 0.63, 0.64, 0.66, 0.68. 0.70, 0.72, 0.74, 0.76, 0.80, 0.85, 0.90, and/or 1.0 cm and or less than about 2.0, 1.5, 1.4, 1.3, 1.25, 1.20, 1.15, 1.1, 1.05, 1.0, 0.5 cm and/or any combination thereof. Additionally, the spacing element can extend from the distal most point of the head of the oral device to the portion of the head proximal to the handle of the oral device. Measuring along the longitudinal axis of the oral device, the length of the spacing element can be greater than about 3, 4, 5, 10, 15, 20, 25, 30 mm and/or less than about 35, 30, 25, 20, 15, 10, 5, 4 mm and/or any combination thereof. The spacing element can have a width of from about 2, 4, 5, 6, 8, 10, 20, 25 mm and/or less than about 30, 20, 10, 8, 6, 5, 4 mm and/or any combination thereof.

In one embodiment the spacing element is translucent and/or transparent. In another embodiment the spacing element is opaque or semi-translucent and/or semi-transparent. The spacing elements can comprise elastomers, including but not limited to thermoplastic elastomers such as polyurethanes, styrene block, copolymers, polyolefins, polyesters, polyamides, poly (vinyl chloride), and/or thermoset elastomers such as silicones, and natural rubber and/or any combination thereof.

To treat various surfaces in the oral cavity with light emitting from the oral device it may benefit the user to know the location of the light emitting element within the oral cavity. The user may be able to visually locate the light by opening the mouth and inspecting with a mirror. However, locating the light emitting element can also be accomplished using the spacing element. The spacing element can provide a sensory signal enabling the user to locate the position of the light without a visual inspection or the use of additional tools, such as a mirror. This may improve the ease of use and increase portability of this device, as the device can be used without the need for additional tools.

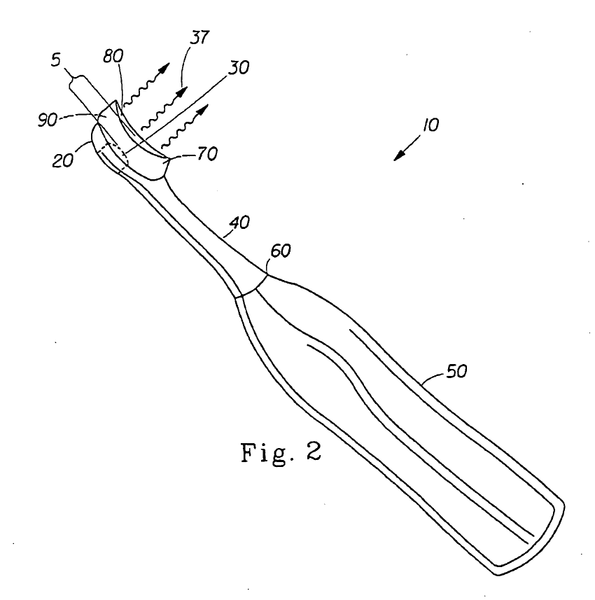

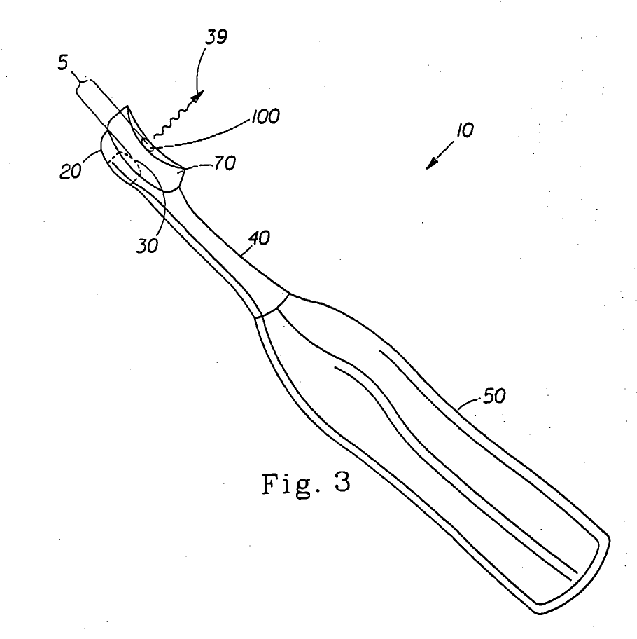

Referring to FIG. 1 an oral device 10 made in accordance with the present invention will now be described. The oral device 10 comprises a light emitting element 30 disposed on a removable/replaceable head 20. The head 20 and neck 40 is severable from the handle 50 at point 60. FIG. 1 further comprises a spacing element 70. In one embodiment the light from the one or more light emitting elements can be spread out and/or defocused by the spacing element so that light can emit from the entire surface of the spacing element as shown by arrows 35 in FIGS. 1. This defocusing can be achieved by a reflective coating on the interior of the spacing element. In another embodiment the spacing element 70 is partially transparent, thereby emitting light along the surface 80, as shown by arrows 37 in FIG. 2. In this embodiment (FIG. 2) the sides 90 of the spacing element 70 are opaque, and the light is emitted only along surface 80 which contacts the oral surface. In another embodiment, shown in FIG. 3, the spacing element comprises an aperture 100. All other surfaces of the spacing element may be opaque and/or not translucent or transparent. Therefore, light emitting from the light emitting element 30 only emits through aperture 100 as shown by arrow 39. In another embodiment the spacing element is completely transparent and/or translucent allowing light to emit from all surfaces of the spacing element. It is contemplated that the surfaces of the spacing element may have varying transparency and translucency to vary the intensity of light that emits from the spacing element. Additionally, the surfaces of the spacing element may have selective transparency or translucency in order to focus the light to provide light in only particular areas, and/or to provide light of greater or lesser intensity.

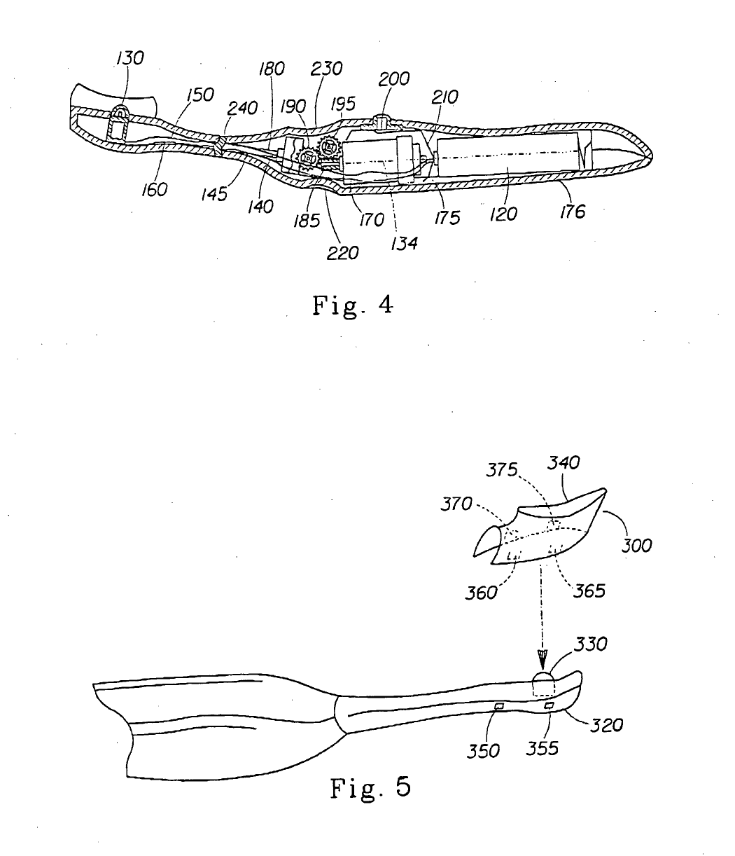

As shown in FIG. 4, a cross section of an oral device of the present invention, the oral device also comprises a power source, such as a battery 120 contained within the multi-purpose handle or a power cord (not shown). The multi-purpose handle can provide power to the head to power the light emitting element via leads 140 and 145 which provide power from the battery 120 to the severable connection and leads 150 and 160 which provide power from the severable connection to the light emitting element 130. The multi-purpose handle also comprises switch 200 which is operatively connected to the battery 120 and the motor 170. When the switch is closed a circuit is completed between the battery 120 and the motor 170 via wire 210, all of which is provided within the hollow portion 175 of the handle 176. The multi-purpose handle can have severable electrical connectors to provide ease of removing and replacing the head such as the severable electrical connectors disclosed in U.S. patent application Ser. No. 10/847429. The multi-purpose handle may further comprise a drive shaft 180 and worm gear 185, and step gears 190 and 195. Step gear 190 is operatively connected to step gear 195 and worm gear 185. Additionally, the multi-purpose handle can comprise gripping portions 220 and 230. A variety of head assemblies can be removed from and attached to the multi-purpose handle at the break 240. The oral device has a longitudinal axis 134. The multi-purpose handle may also comprise multiple switches; one to provide power only to the head assembly and one to operate the motor which can in turn provide motion to a drive shaft.

In one embodiment of the present invention shown in FIG. 1 to 3 the oral device comprises a head 20 having a spacing element in the form of a cap type protuberance 70 which extends over a light emitting element 30. This cap may be a part of the removable replaceable head, or may be a disposable element which can be removed from the head of the oral device and replaced with each use as shown in FIG. 5. The cap can be used with or without an oral care substance, the user can apply the substance to the teeth or the cap prior to use. In the embodiment of the present invention shown in FIG. 5, the spacing element 300 is removable from the head 320 comprising a light emitting element 330. This arrangement allows the user to have a single light emitting element, but a variety of spacing elements which may need replacing due to wear, multiple users, or the cap may be varied in shape and/or size to provide a variety of oral benefits. In FIG. 5 a spacing element cap is shown. This cap has the curved shape 340 of the labial surface of the teeth. The cap is shaped to snap onto the head 320 of the oral device. The head assembly of the oral device may comprise flexible tabs 350, 355 which fit into grooves 360, 365 on the cap to hold the cap 300 in place, but allow for easy removal. Grooves 370 and 375 are shown and these grooves can attach to flexible tabs on the head assembly of the oral device (not shown).

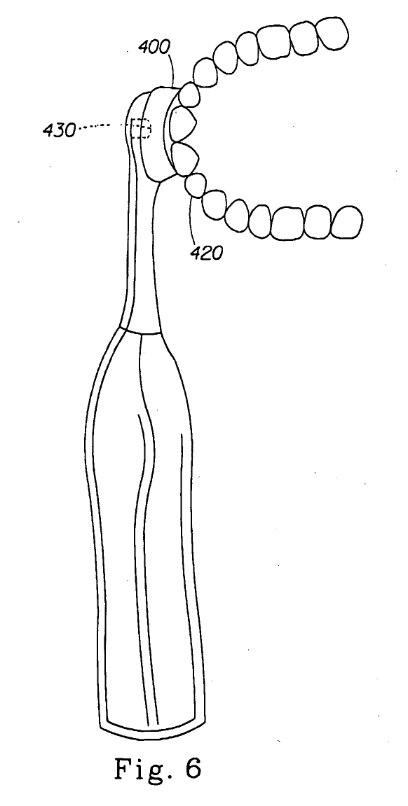

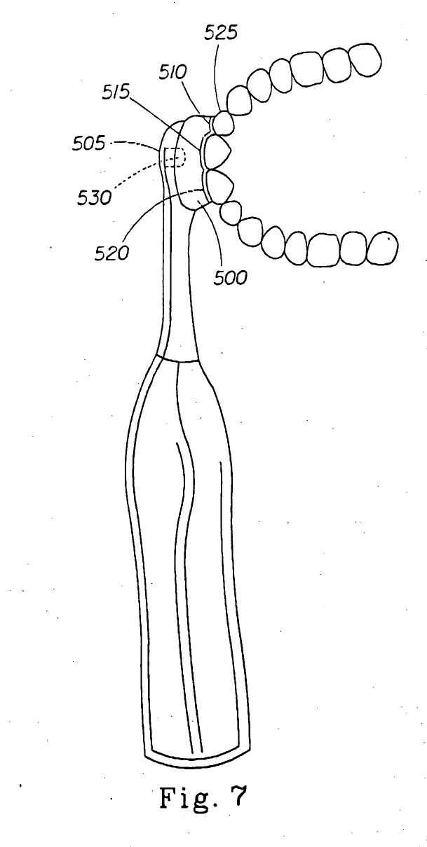

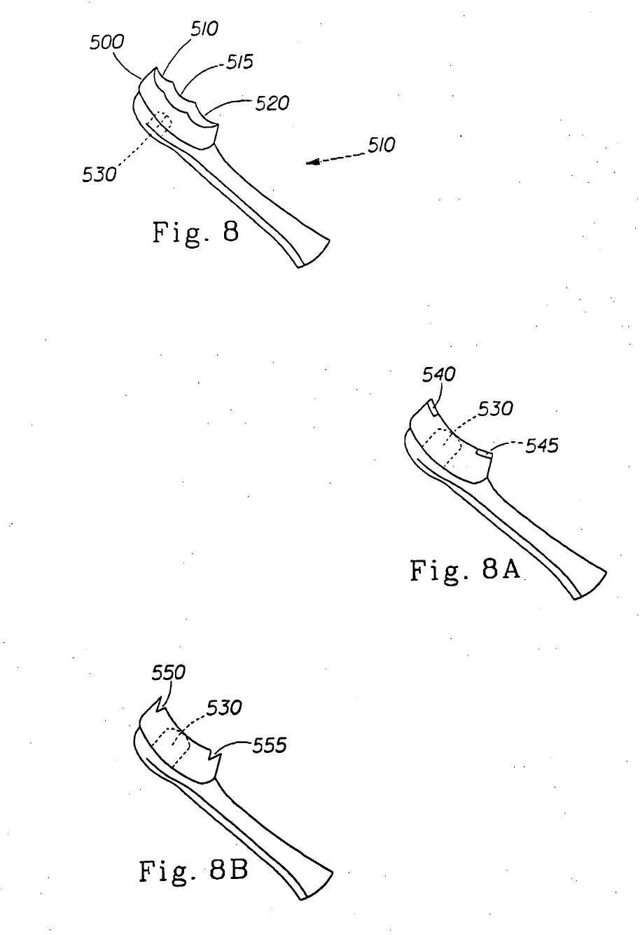

As shown in FIG. 6 the cap-type spacing element 400 can be shaped to fit against the labial surface 420 of multiple teeth. The light can emit from the light emitting element 430 onto the surfaces of the teeth to provide a cosmetic or oral benefit including, but not limited to, whitening and/or antibacterial. The spacing element can be sized to receive labial surfaces of the teeth within grooves to allow for the proper placement of the light emitting element as well as ease of holding the light emitting element against the teeth. FIGS. 7-8 are an illustration of the head 505 comprising the spacing element 500 comprising grooves 510, 515 and 520 for the teeth 525. Light emitting element 530 is disposed on the head 505 within the spacing element 500 and emits light through spacing element 500.

The surface of the spacing element may comprise a groove, a notch, or a textural difference which can provide a sensory signal to the use to indicate the location of the light emitting element within the oral cavity. An embodiment comprising grooves 510, 515, and 520 is shown in FIG. 8. An embodiment comprising a textural difference, such as a patch 540 and 545 is shown in FIG. 8A The patch can be any material that has a different surface texture than the material of the spacing element. An embodiment comprising a groove 550 and 555 is shown in FIG. 8B. The spacing elements can be tactilely detected by the user within the oral cavity, as the user will be able to feel on the oral surface the textured patch or the grooves and therefore feel the approximate location of the light emitting element 530.

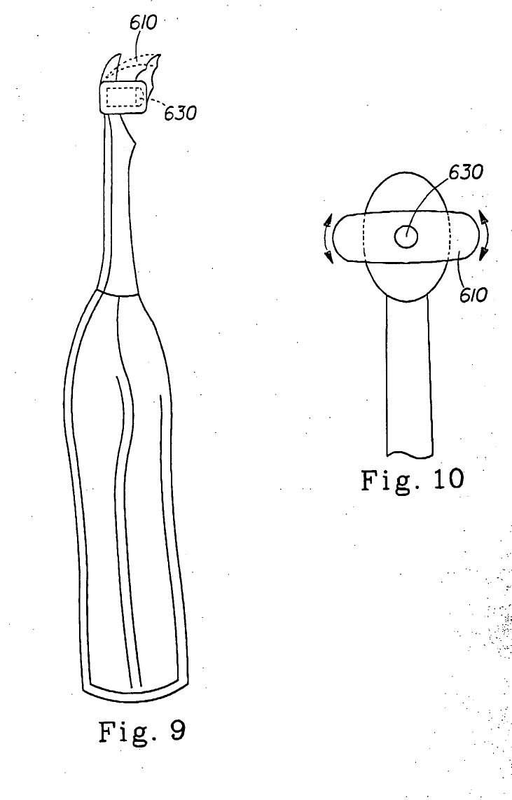

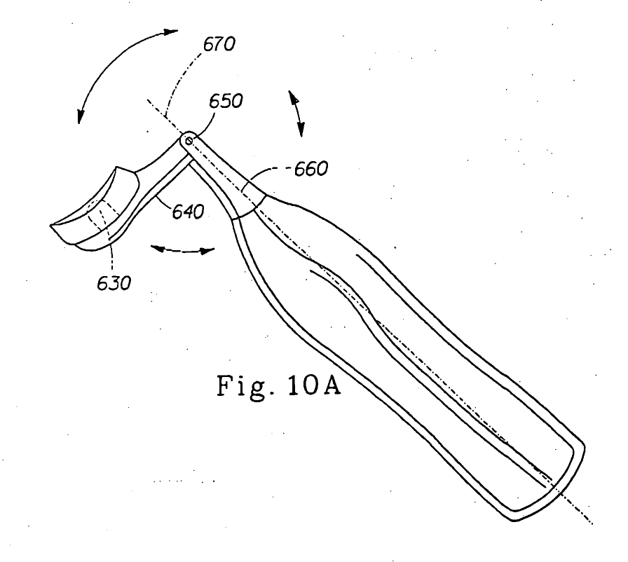

The spacing element may also turn on an axis perpendicular to the head. In one embodiment the light emitting element 630 is the axis around which the spacing element 610 turns, as shown in FIGS. 9-10. The light emitting element may be disposed within a protective column or the light emitting element may have a coating to provide additional durability to the light emitting element as an axis point. The coating can comprise any material including but not limited to metals, polymers and or any other material that reinforces or strengthens the light emitting element. Further, the neck of the oral device can have a joint and/or a swivel which enables the user to move the head assembly to position the head of the oral device as shown in FIG. 10A. In one embodiment a joint 650 is disposed between the head 640 and the neck 660 which allows the head to move such that the head is angled away from the longitudinal axis 670 of the oral device. In one embodiment the head comprises a light emitting element 630.

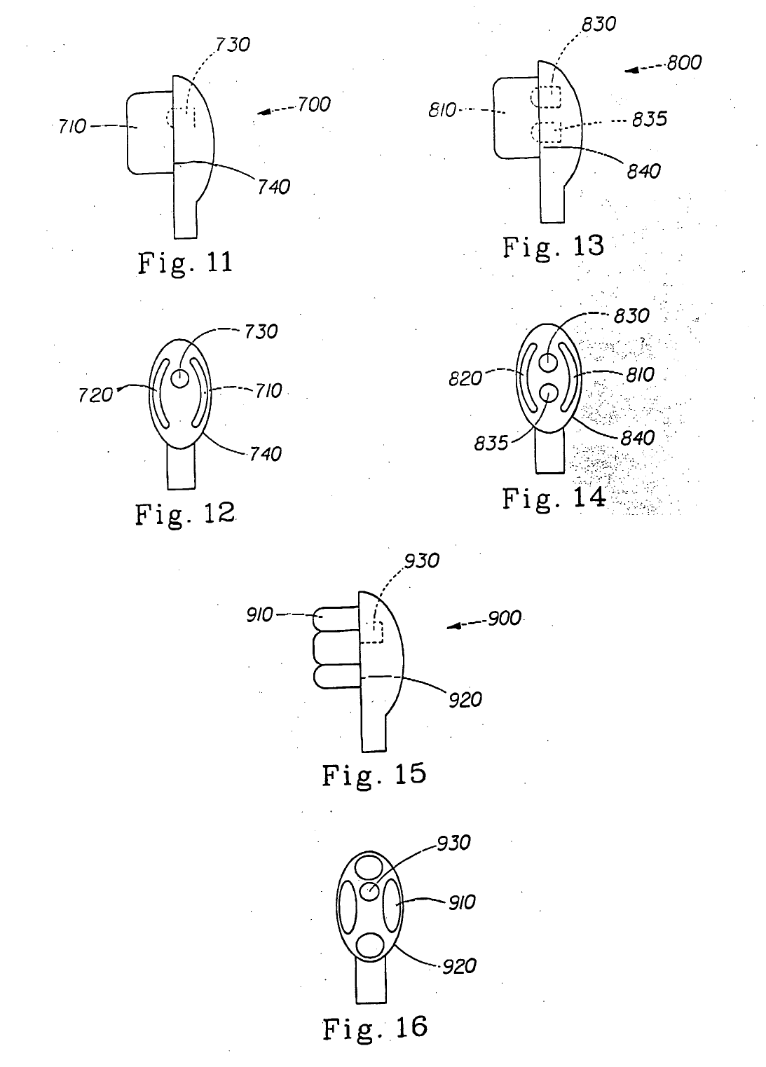

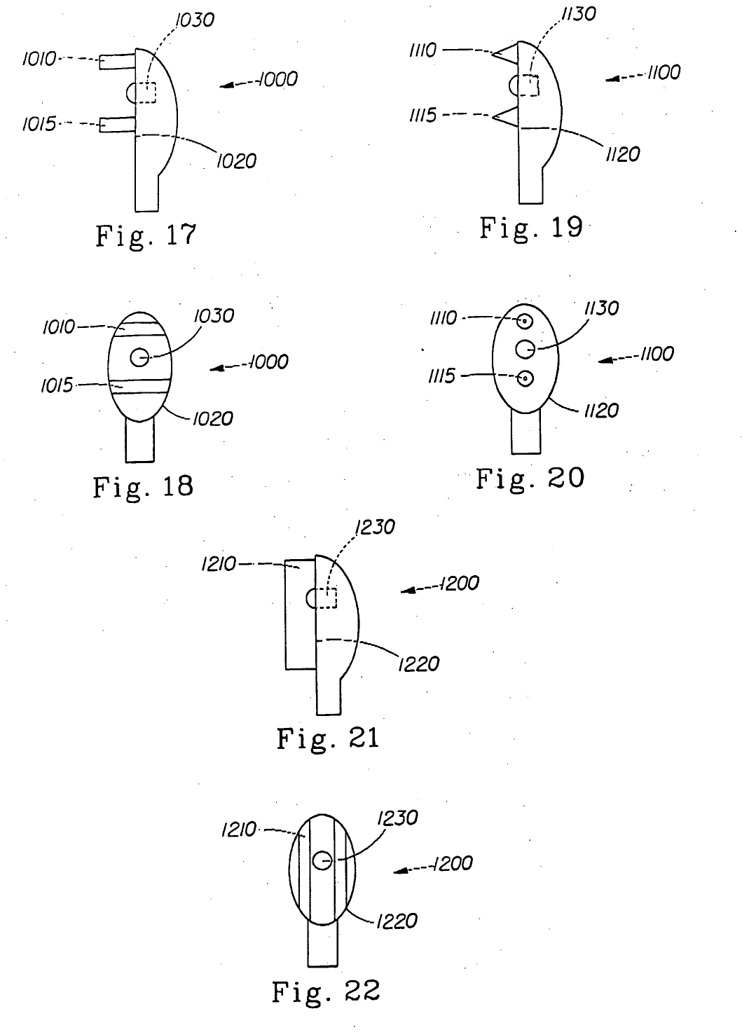

In the embodiments shown in FIGS. 11-22 the spacing element is an elastomeric protuberance. These elastomeric spacing elements are flexible enough to provide comfort to the user, but substantive enough that the desired distance between the light emitting element and the oral surface to be illuminated is maintained. The head of the oral device can have one light emitting element as shown in FIGS. 11-12 or multiple light emitting elements as shown in FIGS. 13-14. FIGS. 11-12 show the head 700 of an oral device, comprising two curved elastomeric walls 710, 720 extending perpendicularly to the surface 740 of the head 700. FIGS. 11-12 also show a light emitting element 730 disposed on the head 700. FIGS. 13-14 show oral device head 800 comprising two elastomeric walls 810, 820 extending perpendicular to surface 840, and multiple light emitting elements 830, 835 disposed on the head 800. FIGS. 15-16 show a light emitting oral device head 900 comprising elastomeric cylinders 910 extending perpendicularly to the surface 920 of the head 900. The head comprises a light emitting element 930. FIGS. 17-18 show a light emitting oral device head 1000 comprising rectangular elastomeric bars 1010, 1015 disposed on the head, extending perpendicularly to the surface 1020. The head further comprises a light emitting element 1030. FIGS. 19-20 show a head 1100 comprising elastomeric rods 1110, 1115 which are pointed. These elastomeric rods are disposed perpendicularly to surface 1120 of the head. The head further comprises a light emitting element 1130. FIGS. 21-22 show a light emitting oral device head 1200 having elastomeric bars 1210, 1215 which extend perpendicularly to the surface 1220. These bars extend along horizontally from the distal most point of the head 1240 of the oral device to the portion of the head of the oral device proximal to the neck 1250. The head further comprises a light emitting element 1230.

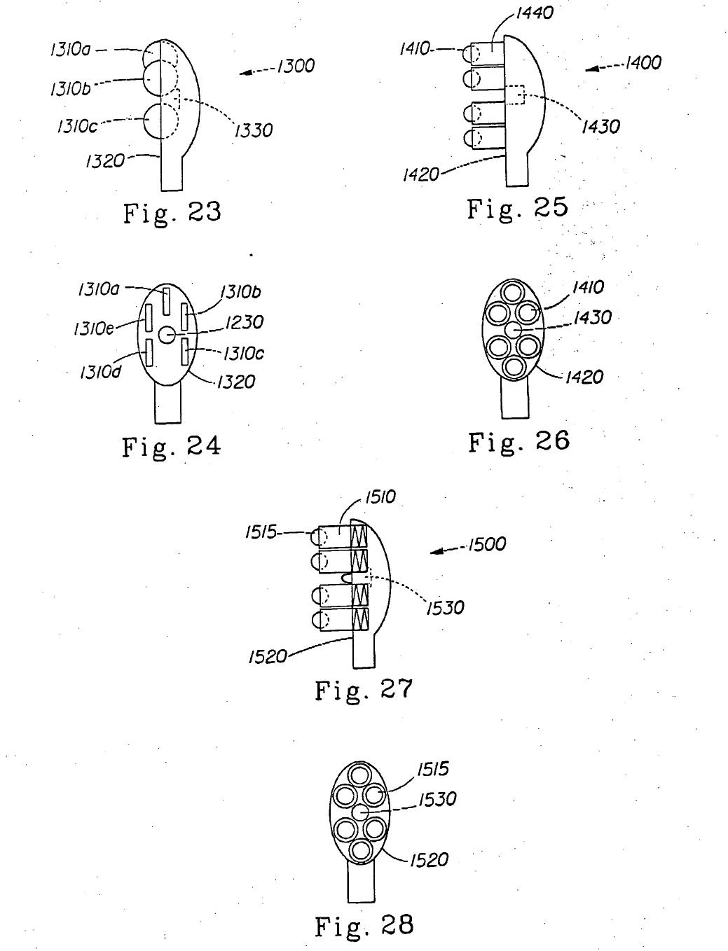

In another embodiment as shown in FIGS. 23-26 the spacing element is a roller or a ball. The head 1300 as shown in FIGS. 23-24 comprises ball elements 1310a, 1310b, 1310c, 1310d, and 1310e and a light emitting element 1330 extending from surface 1320. In one embodiment the balls 1310a, 1310b, 1310c, 1310d, 1310e, and 1310e can roll along the oral surface to treat the surface with light emitting from the light emitting element 1330. In another embodiment the balls 1310a, 1310b, 1310c, 1310d, and 1310e remain stationary. The head can comprise one or more balls, and the balls can be arranged in any pattern. As shown in FIGS. 23-24 the balls 13 10a, 1310b, 1310c, 1310d, and 1310e can be arranged to surround the light emitting element 1330. In addition to indicating to the user the distance between the light emitting element and the oral surface, the ball elements can also indicate to the user the position of the light emitting element, as the user can feel the balls as they roll along the oral surface. The user will know that the light emitting element is placed between the balls.

FIGS. 25-26 illustrate oral device head 1400. Head 1400 comprises ball elements 1410 in columns 1440 extending in a direction perpendicular to surface 1420. The head 1400 further comprises at least one light emitting element 1430. The ball elements 1410 can provide additional comfort and ease of use. The columns 1440 can indicate to the user the proper distance between the light emitting element and the oral surface to be treated. Additionally, the ball elements can stimulate a sensory response in the user, allowing the user to feel the location of the ball elements and therefore know the location of the light emitting element. The user can confirm the location of the light emitting element by visually inspecting the head of the oral device prior to placing the device into the oral cavity. The user can note the location of the light emitting element in relation to the balls which the user will be able to feel within the oral cavity. In the embodiment illustrated in FIGS. 27-28 the head 1500 comprises balls 1515 are within spring loaded columns 1510 extending in a direction perpendicular to surface 1520. The spring loaded columns may provide the user with additional comfort during use. The spring loaded columns can be in any arrangement, as shown in FIGS. 27-28 the spring loaded columns encircle the light emitting element 1530.

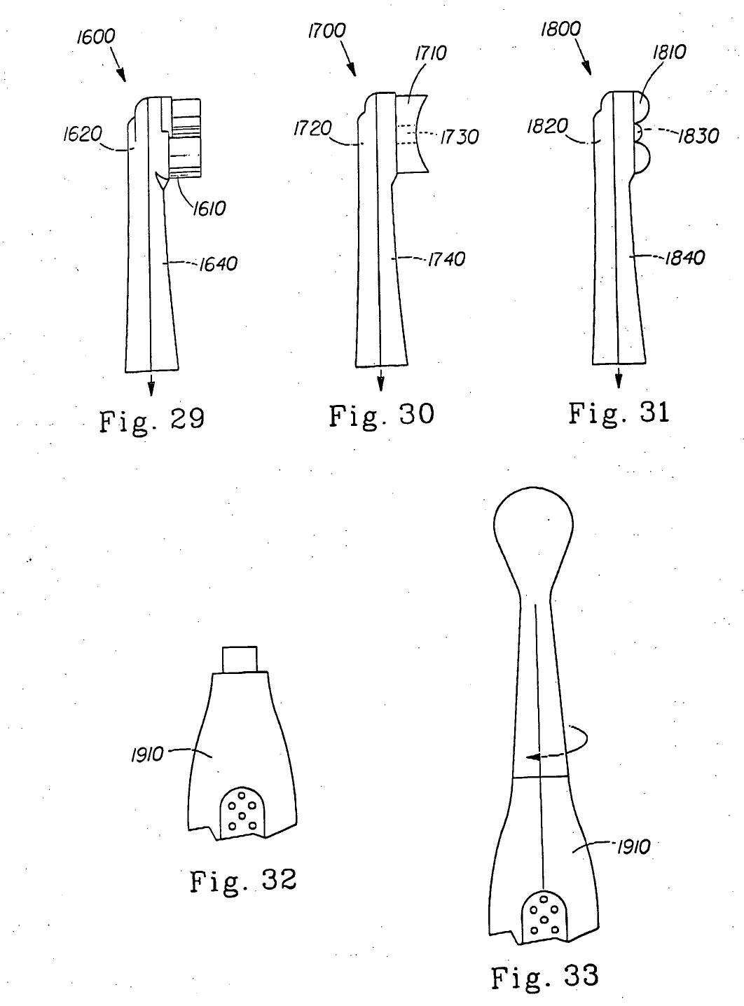

The oral device may be part of a kit, which further comprises a variety of removable/replaceable head assemblies each of which provides different benefits to the oral cavity. In one embodiment of a kit according to the present invention, one of the head assemblies 1600 comprises a head 1620 having bristles 1610 disposed thereon, and a neck 1640 as shown in FIG. 29. Another one of the removable replaceable head assemblies 1700 comprises a bristle-less head 1720 having a light emitting element 1730 and a cap type spacing element 1710 disposed on the head 1720 as shown in FIG. 30. Head 1700 further comprises a neck 1740. At least a portion of this cap type spacing element can be transparent and translucent and the surface which contacts the oral surface is curved to provide the desired contact between the spacing element and the labial surfaces of a plurality of teeth. The kit further comprises a light emitting head assembly 1800 comprising a head 1820 having a light emitting element 1830 and a roller-type spacing element 1810 disposed thereon as shown in FIG. 31. These rollers can contact the mucosal surfaces of the oral cavity to provide treatment to the mucosal tissue of the oral cavity. This head assembly also comprises a neck 1840. The kit further comprises a multi-purpose handle 1910 as partially shown in FIGS. 32-33. Each of the head assemblies shown in FIGS. 29-31 can attach to the multi-purpose handle 1910 as shown in FIG. 33. The kit can further comprises compositions which provide a oral benefit, including, but not limited to, compositions for tooth whitening, anti-bacterial, breath freshening, and/or anti-viral.

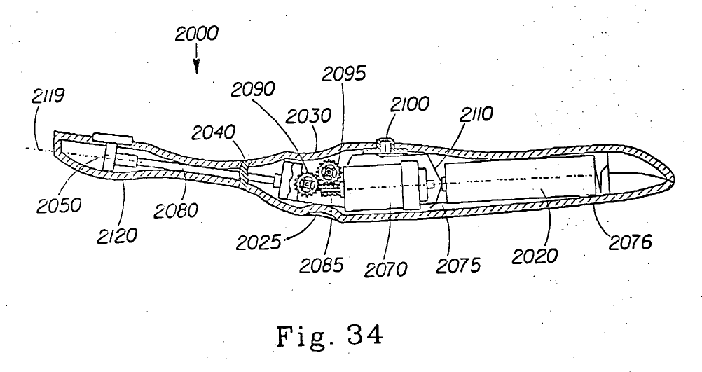

If the multi-purpose handle is attached to a head assembly comprising movable bristle plates (as shown in FIG. 34), the oral device 2000 can further comprise a drive shaft 2080 which is operatively connected to the movable bristle plate 2050. When the oral device is in operation the motor 2070 powers the movable bristle holder 2050 through a drive shaft 2080. The gearing arrangement includes a worm gear 2085 and a pair of step gears 2090 and 2095. The motor is operatively connected to the worm gear 2085. Step gear 2095 is operatively connected to step gear 2090 and the worm gear 2085. The oral device can further comprise a switch 2100 provided to control operation of the oral device. The switch is operatively connected to the motor. When the switch 2100 is closed a circuit is completed between the battery 2020 and the motor 2070 via wire 2110. The battery and the motor can both be housed within the cavity 2075 of the handle 2076. The head assembly 2120 can be attached to the multi-purpose handle 2076 at break 2040. The oral device has a longitudinal axis 2119.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An electric oral device comprising:
(a) a handle, and
(b) a bristle-less head assembly;
(b) wherein said bristle-less head assembly comprises at least one light emitting element which is operatively connected to a power source, and further comprises a spacing element for providing a distance between said light emitting element and an oral surface.

2. The electric oral device of claim 1, wherein said spacing element comprises at least one protuberance.

3. The electric oral device of claim 2, wherein said protuberance comprises an elastomer.

4. The electric oral device of claim 2, wherein said protuberance is a cap which extends over the light emitting element.

5. The electric oral device of claim 4, wherein said cap is contoured in the shape of a labial surface of one or more teeth.

6. The electric oral device of claim 2, wherein said protuberance is a cylinder.

7. The electric oral device of claim 2, wherein said protuberance is a semi-circle.

8. The electric oral device of claim 1, wherein said spacing element comprises rollers.

9. The electric oral device of claim 1, wherein said spacing element rotates.

10. The electric oral care device of claim 1, wherein said head assembly rotates.

11. The electric oral device of claim 1, wherein said spacing element signals to the user the location of the light emitting element within the oral cavity.

12. The electric oral device of claim 11, wherein said spacing element signals to the user the location of the light emitting element within the oral cavity with a sensory indicator.

13. The electric oral device of claim 12, wherein said sensory indicator is a protuberance.

14. The electric oral device of claim 12, wherein said sensory indicator is a groove.

15. The electric oral device of claim 12, wherein said sensory indicator is a textural difference.

16. An electric oral device comprising:
(a) a handle, and a bristle-less head assembly;
(b) wherein said bristle-less head assembly comprises a light emitting element and a spacing element, said spacing element comprising a wall extending in a direction perpendicular to the head assembly, wherein said spacing element provides a distance between said light emitting element and an oral surface.

17. The electric oral device of claim 16, wherein said wall comprises one or more individual structural units.

18. The electric oral device of claim 17, wherein said wall comprises one or more protuberances.

19. A method of whitening the teeth comprising:
exposing the labial surfaces of the teeth to light having a wavelength of from about 420 to about 490 nanometers;
wherein said light emits from an oral device comprising a bristle-less head assembly having a light emitting element and a spacing element, wherein said spacing element provides a distance of from about 0.1 to about 1.0 cm measured from said light emitting element to an oral surface, and wherein said spacing element comprises less than four protuberances.

20. An oral care kit comprising:
(a) a multi-purpose handle comprising a power source and a motor; and
(b) two or more removable head assemblies, wherein at least one of said head assemblies is bristle-less and comprises a light emitting element, and wherein at least one of said head assemblies comprises a movable bristle holder which is operatively connected to said motor.
